(19) United States
(12) Patent Application Publication
(10) Pub. No.: US 2016/0059792 A1
(43) Pub. Date: Mar. 3, 2016

(54) Dashboard Article Holder

(71) Applicant: Shannon Pappert, Guilford, CT (US)

(72) Inventor: Shannon Pappert, Guilford, CT (US)

(21) Appl. No.: 14/734,034

(22) Filed: Jun. 9, 2015

Related U.S. Application Data
(60) Provisional application No. 62/009,395, filed on Jun. 9, 2014.

(51) Int. Cl. B60R 11/00; F16M 11/04; F16M 11/22

(52) U.S. Cl. CPC B60R 11/00; F16M 11/22; F16M 11/041; B60R 2011/0063; B60R 2011/0005

(57) ABSTRACT

An article holder for holding sunglasses is provided, wherein the article holder is configurable to look like a character or object. The article holder includes a holder body having, a body bottom, wherein the body bottom is configured to be weighted, and a body top, wherein the body top includes nose and a glass arm notch, wherein the body top is configured to securely associate with a pair of glasses such that the arms of the pair of glasses are located within the glass arm notch and such that the nose of the body top is located within the bridge cavity of the glasses.

### RELATED APPLICATIONS

This application is related to and claims benefit from U.S. Provisional Patent Application Ser. No. 62/009,395, filed Jun. 9, 2014, titled “Dashboard Dudes”, the contents of which are incorporated by reference herein in its entirety.

### FIELD OF THE INVENTION

The present invention relates to an article holder and more particularly to an article holder that is configured for loosely associate with a flat surface, such as the dashboard of a vehicle.

### BACKGROUND OF THE INVENTION

People wear glasses for a variety of reasons, such as to correct for defects in their vision or to limit the amount of sun exposure to their eyes and to make it easier to see. One problem people who wear glasses have is that when they are not wearing the glasses, it is easy to lose them, especially in vehicle. Although a large number of vehicles include a compartment for containing glasses, these compartments are limited in size and can only accommodate smaller sized glasses. And while there are many places to put your glasses in a vehicle, such as the car seat, the glove compartment, pocket book, etc. . . . these places are either not convenient or they expose the glasses to being broken or lost.

### SUMMARY OF THE INVENTION

An article holder for holding sunglasses is provided, wherein the article holder is configurable to look like a character or object. The article holder includes a holder body having, a body bottom, wherein the body bottom is configured to be weighted, and a body top, wherein the body top includes nose and a glass arm notch, wherein the body top is configured to securely associate with a pair of glasses such that the arms of the pair of glasses are located within the glass arm notch and such that the nose of the body top is located within the bridge cavity of the glasses.

### BRIEF DESCRIPTION OF THE DRAWINGS

The foregoing and other features and advantages of the present invention will be better understood from the following detailed description of illustrative embodiments, taken in conjunction with the accompanying drawings in which:

FIG. 1 is a side view of the article holder, in accordance with one embodiment of the invention.

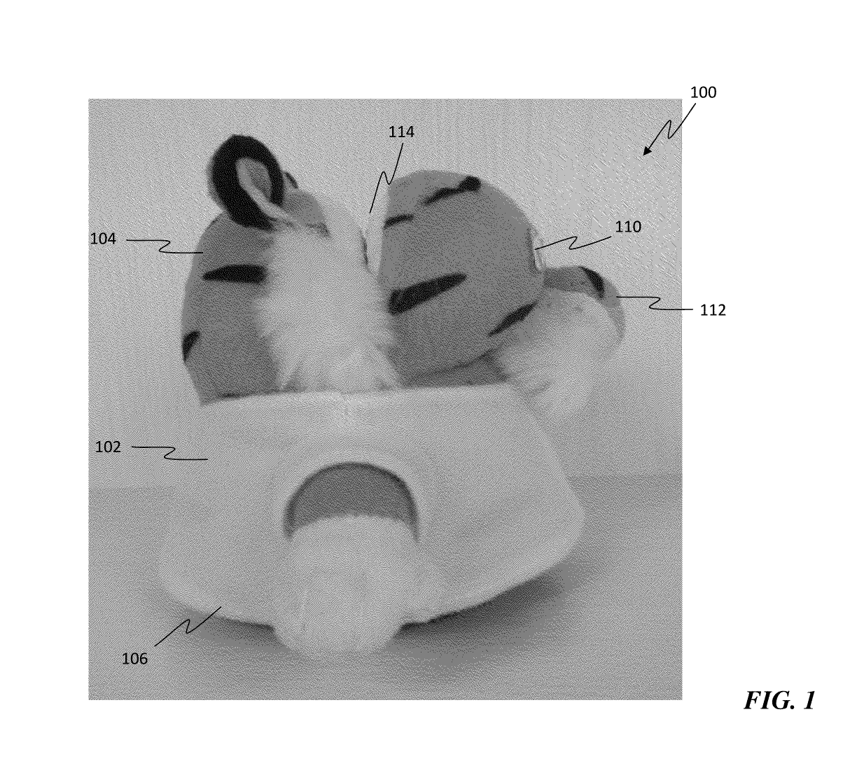

FIG. 2 is front view of the article holder of FIG. 1.

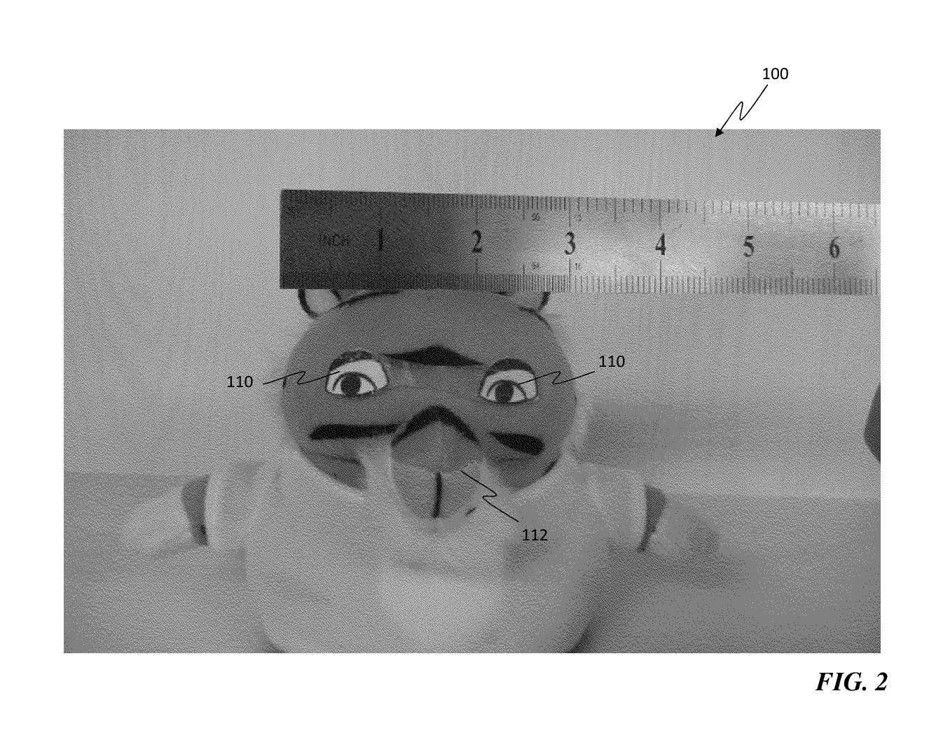

FIG. 3 is side view of the article holder of FIG. 1, laying on its back.

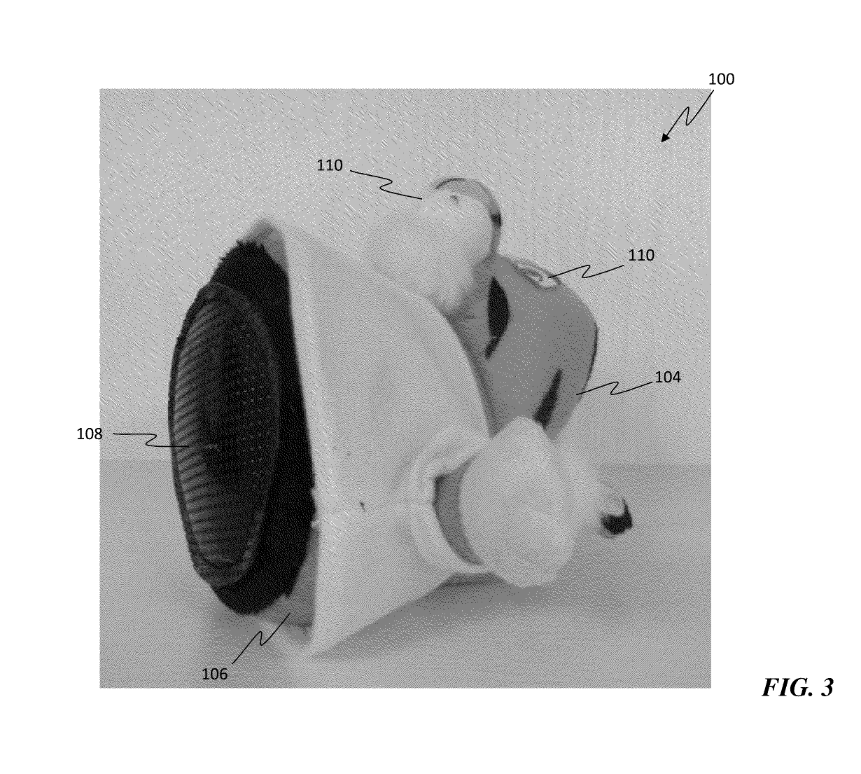

FIG. 4 is a back view of the article holder of FIG. 1.

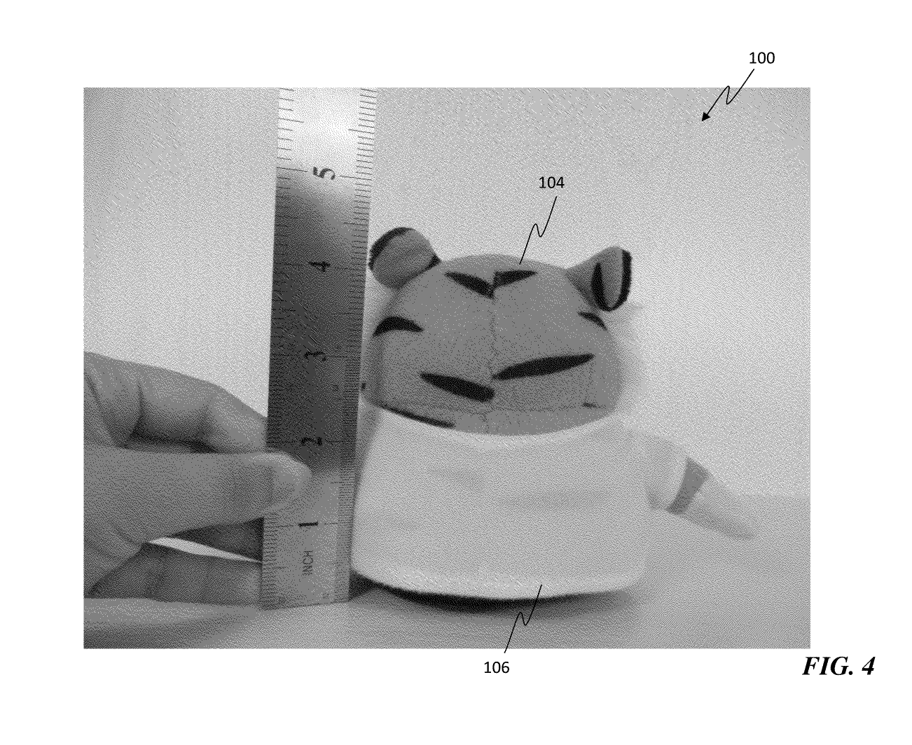

FIG. 5 is a side view of the article holder of FIG. 1.

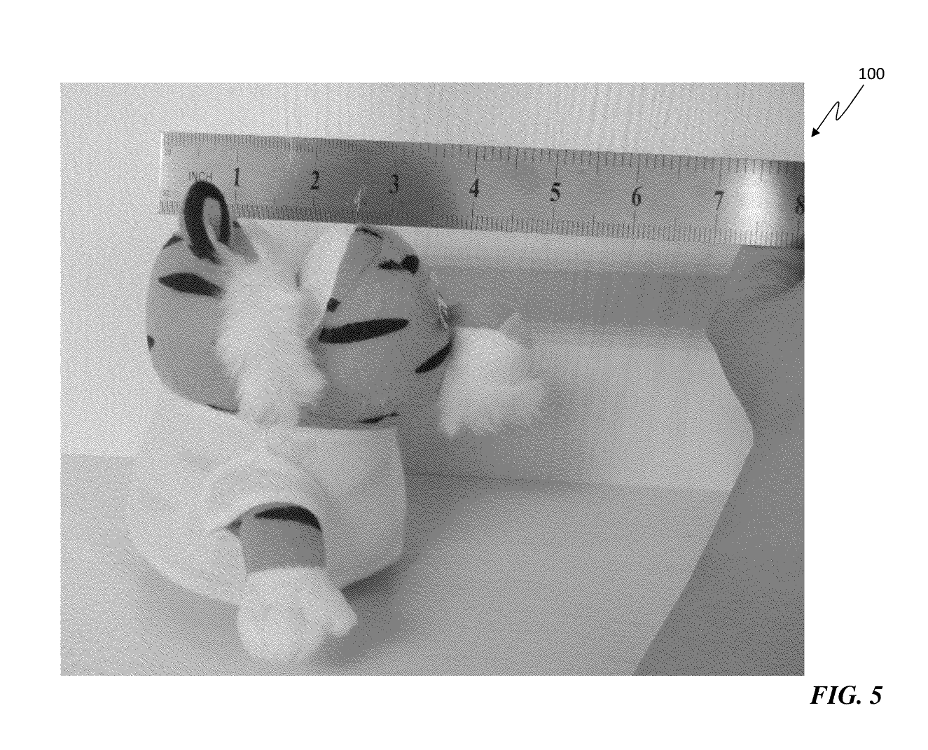

FIG. 6 is a front side perspective view of the article holder of FIG. 1.

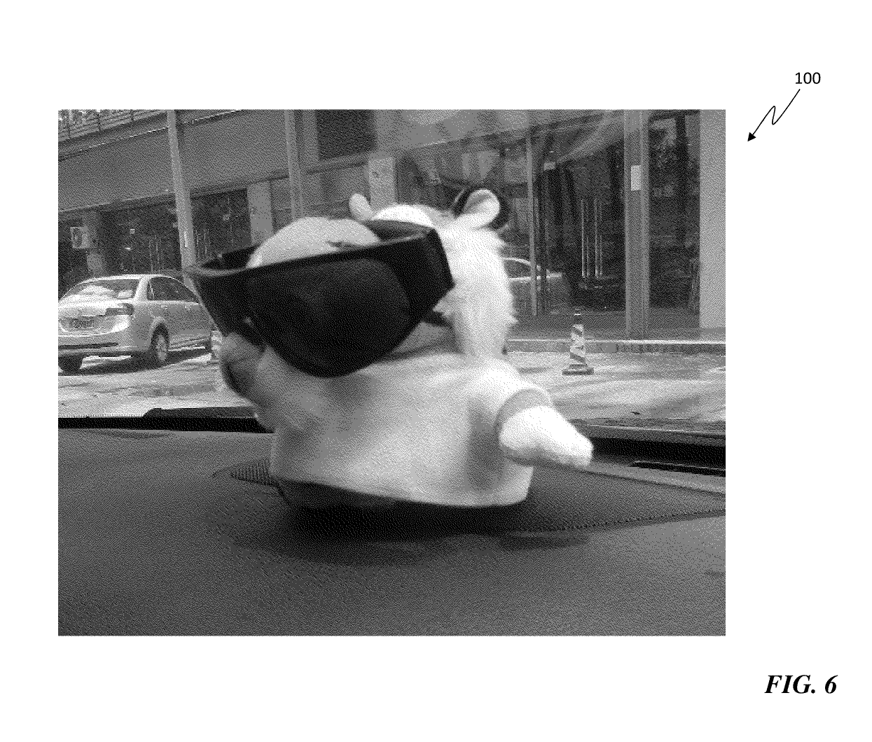

FIG. 7 is a front side perspective view of the article holder of FIG. 1.

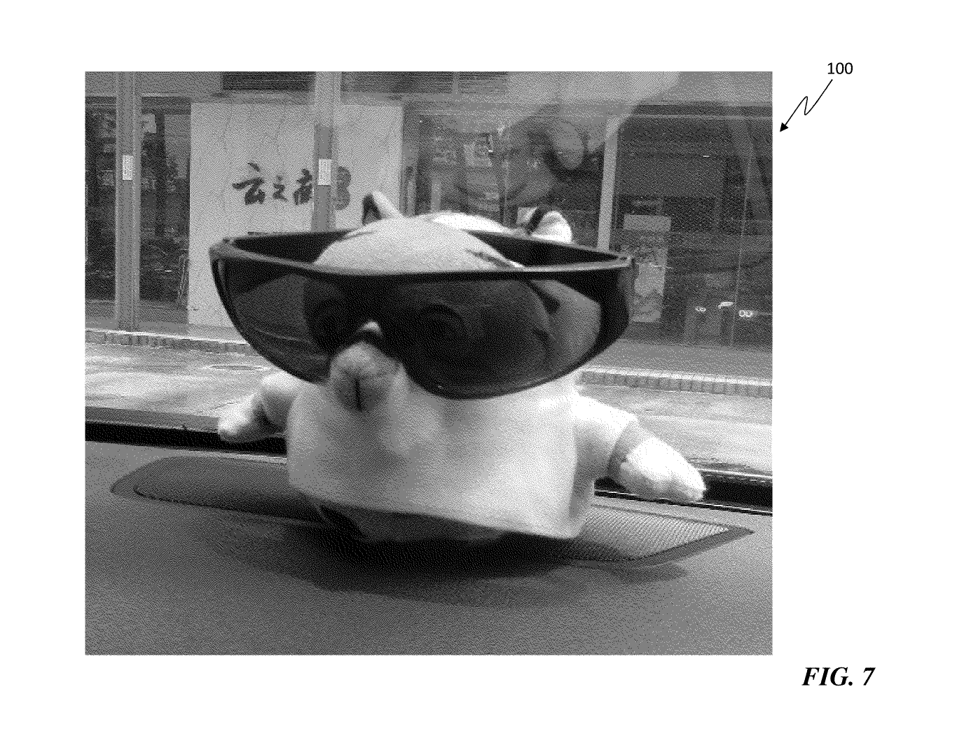

FIG. 8 is a bottom up view of the article holder of FIG. 1.

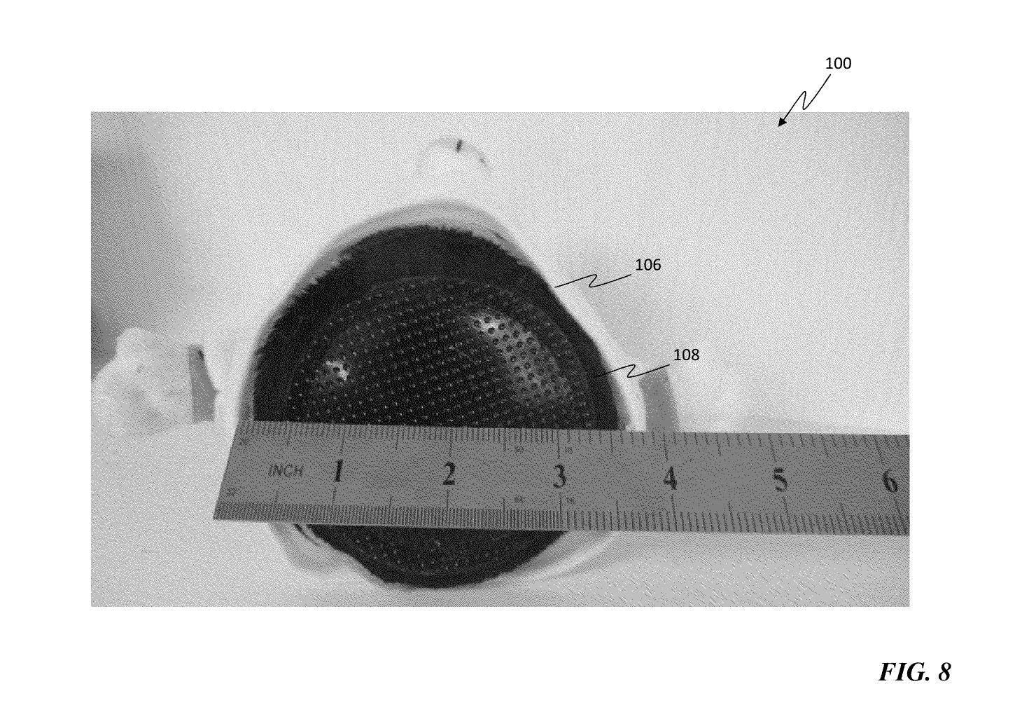

FIG. 9 is a side view of the article holder of FIG. 1.

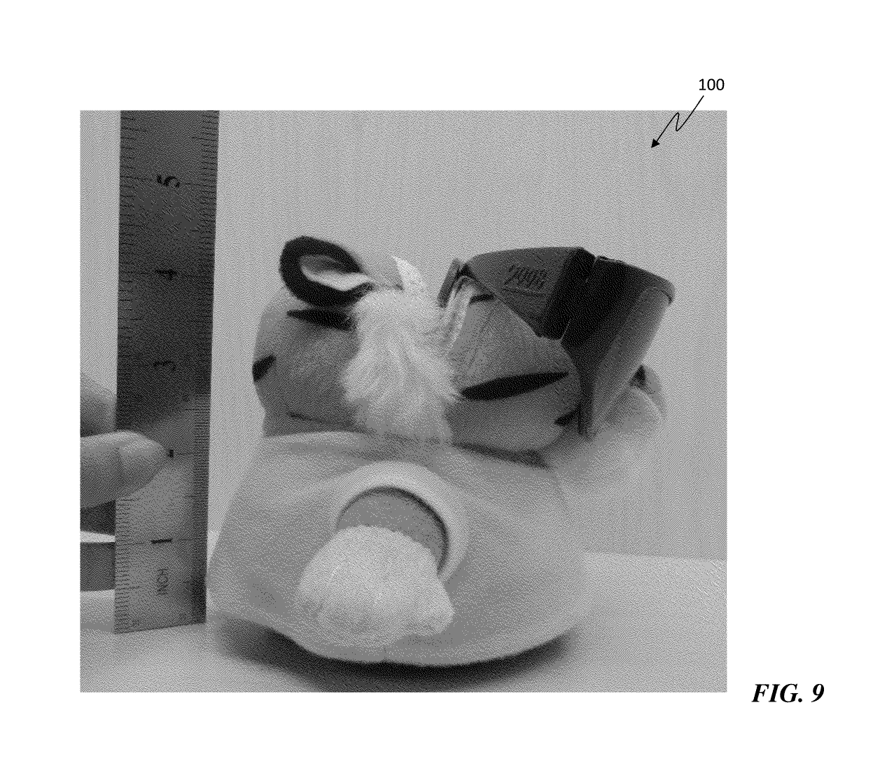

FIG. 10 is a front view of the article holder of FIG. 1.

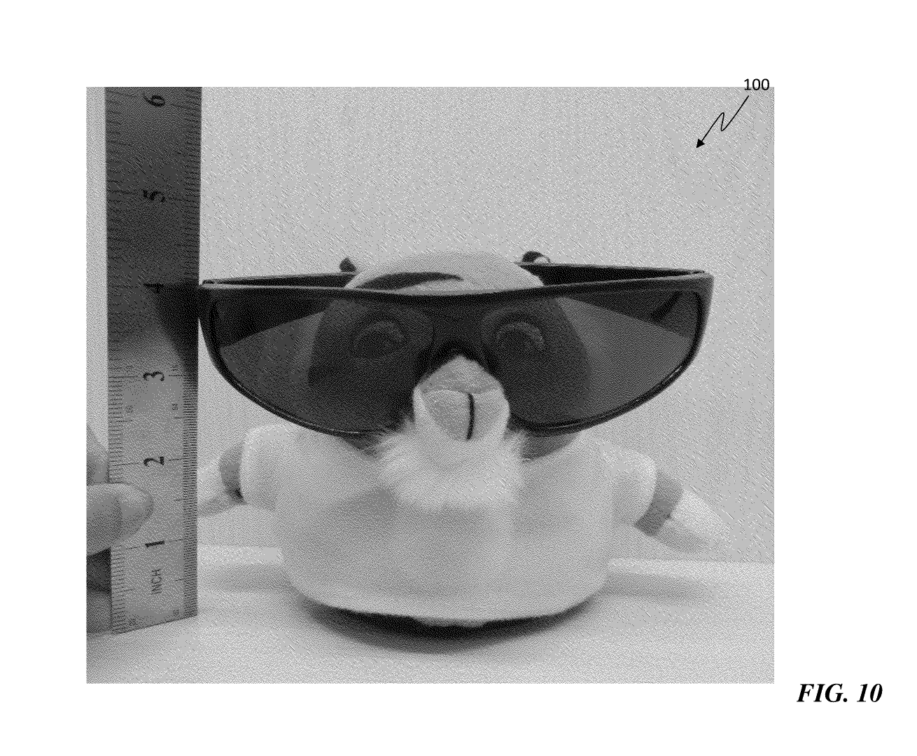

FIG. 11 is an illustration of the article holder of FIG. 1 showing glasses being associated with the article holder, in accordance with one embodiment of the invention.

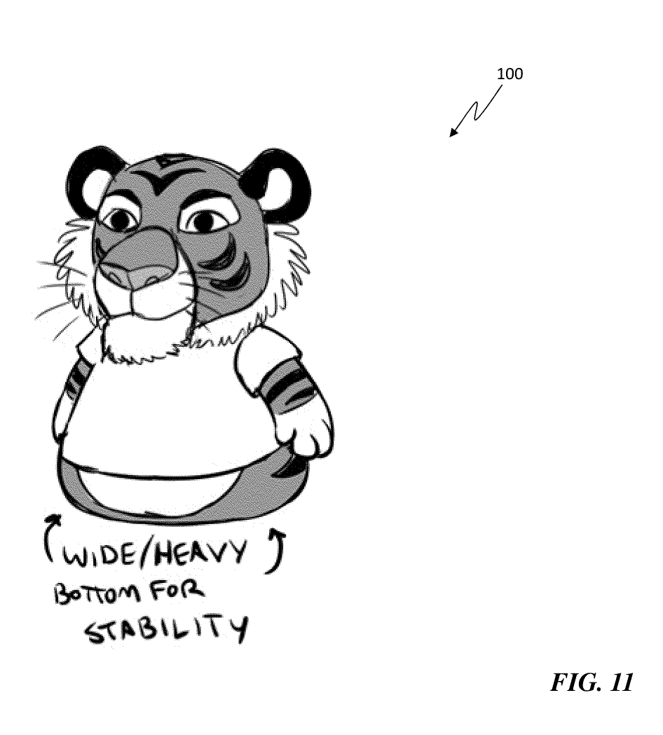

FIG. 12 is an illustration of the article holder of FIG. 1 showing glasses being associated with the article holder, in accordance with one embodiment of the invention.

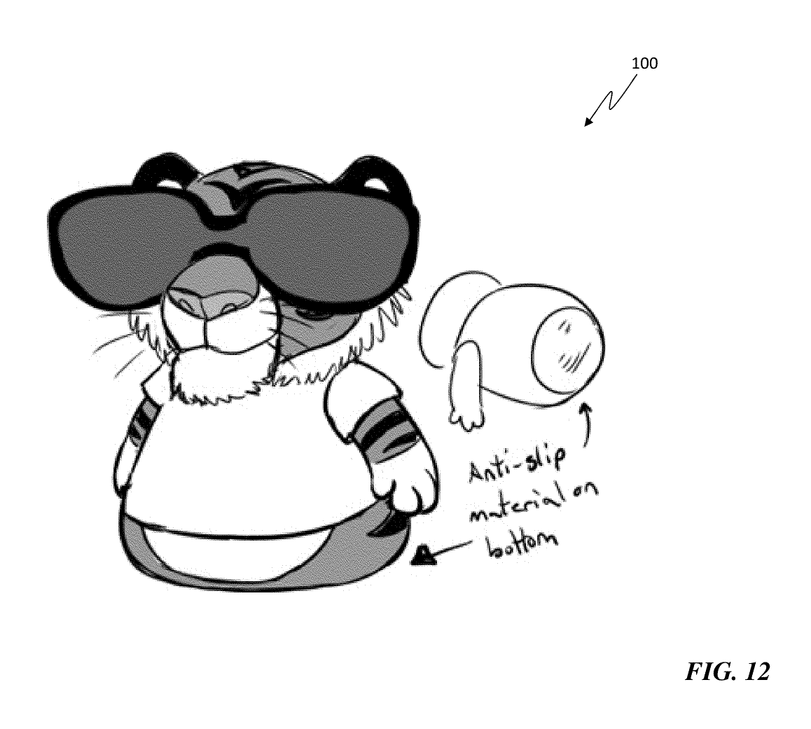

FIG. 13 is an illustration of the article holder of FIG. 1 showing glasses being associated with the article holder, in accordance with one embodiment of the invention.

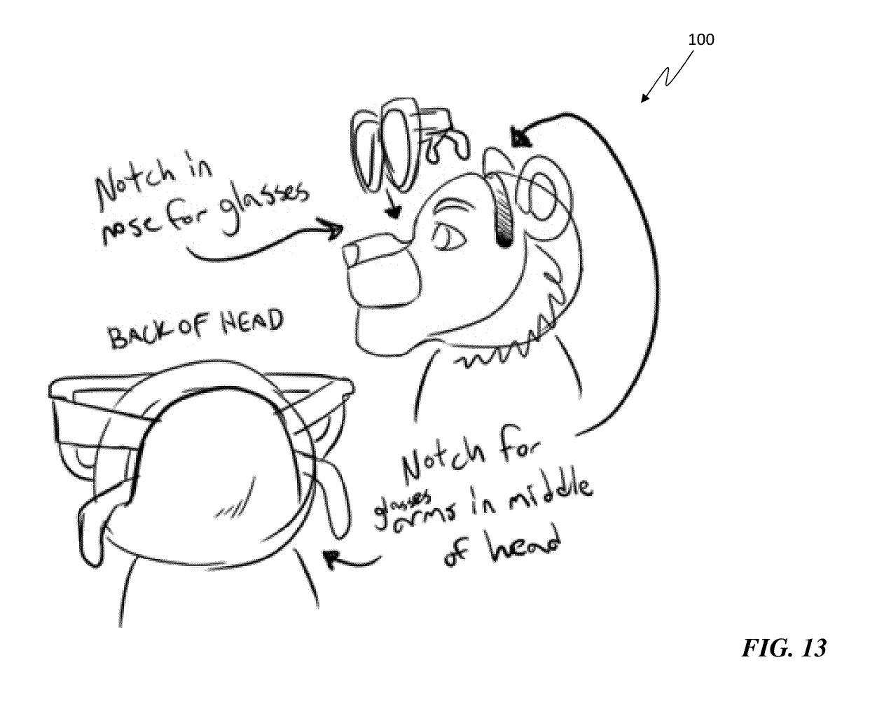

### DETAILED DESCRIPTION OF THE INVENTION

In accordance with an embodiment of the invention, a dashboard article holder is provided and is configured to sit securely on the dashboard of a vehicle or other flat surface. The article holder, which is configured as a character having eyes and a nose, includes a padded glass arm notch located behind the eyes. When the glasses are associated with the article holder, the glasses are positioned such that the lenses are located adjacent the eyes, the nose is located within the cavity below the bridge of the glasses such that nose pads are resting on the nose and the glass arms are securely located within the glass arm notch. Thus, the article holder is configured to ‘wear’ the glasses. Accordingly, the article holder allows drivers and passengers (of cars, boats, trucks, etc.) to safely and securely store their glasses on their vehicle/boat dash board where they will be easily accessible.

Referring to the FIGS., the article holder 100 is provided and includes a holder body 102 having a body top 104 and a body bottom 106, wherein the body bottom 106 is configured to be weighted. For example, in one embodiment, the body bottom 106 is weighted and is configured to contain about 125g of weighted pellets. It should be appreciated that in other embodiments, the body bottom 104 may include an outer surface 108 which is constructed from a non-slip (or tacky) material and/or the outer surface 108 may be treated with an automobile-grade adhesive to ensure that the article holder 100 remains in place on the dashboard.

In accordance with the invention, the body top 104 resembles the face of a character and includes a pair of eyes 110 and a padded nose 112. The body top 104 also includes a glass arm notch 114 (may or may not be padded) located on the body top 104. It should be appreciated that when a pair of glasses are associated with the article holder 100, the lenses of the glasses are located proximate to the eyes 110 to cover the eyes 110 and the nose 112 is located within the bridge cavity of the glasses such that the nose pads of the glasses are resting on the nose 112. Additionally, the glass arms of the glasses are folded over each other and located within the glass arm notch 114. In at least one embodiment, the body top 104 is padded such that the glass arm notch 114 is padded, thereby allowing the glass arms of the glasses to be snugly and securely contained with the glass arm notch 114. Additionally, the nose 112 is sized to fit snugly and securely within the bridge cavity of the glasses. This advantageously allows the glasses to be securely associated with the article holder 100. It should be appreciated that article holder may be at least partially constructed from synthetic plush material (outer layer) and filled with a synthetic batting (as typically used for stuffed animal toys) that may be ICTI CARE certified.

It should be appreciated that in at least one embodiment, the glass arm notch is constructed with a “V” shaped slit behind the “face” to hold folded sunglasses arms. The “face” also will offer a “nose” or other jetting out feature that allows the nose piece of the sunglasses to securely sit.

Moreover, it is contemplated that in other embodiments, the body bottom 106 may be configured with a base plate, whereby the article 100 includes the option of magnetizing to a separate, metal, base plate that is placed on the dashboard using automotive-grade sticky tape. In this embodiment, the article holder 100 may be constructed with a magnet placed inside, lying flat on the very bottom (below the weighted pellets) which allows it to “magnetize” to this metal plate. This would allow other shaped article holders 100 to be used with the same base plate.

It is further contemplated that the article holder 100 may be configured into any shape desired, such as an animal, mascot, person, insect, cartoon character, legendary creature and/or inanimate object. Moreover, the article holder 100 may come with different coverings (clothing) to allow a user to accessorize and/or personalize the article holder 100. For example, the article holder 100 is configured to wear shirts that may be changed as desired. The shirts may include corporate or sport logos and thus may be used as an advertising platform.

Furthermore, in additional embodiments. the article holder may include additional compartments and/or be configured to hold any other articles as desired, such as air fresheners, cells phones, technical devices, cups, hand sanitizers, etc. In one embodiment, the article holder 100 may be about 4½ inches tall and about 4 inches wide at its base and although

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims and/or information. Moreover, unless specifically stated any use of the terms first, second, etc. do not denote any order or importance, but rather the terms first, second, etc. are used to distinguish one element from another.

I claim:

1. An article holder for holding sunglasses, wherein the article holder is configurable to look like a character or object, the article holder comprising:
a holder body having,
a body bottom, wherein the body bottom is configured to be weighted, and
a body top, wherein the body top includes nose and a glass arm notch, wherein the body top is configured to securely associate with a pair of glasses such that the arms of the pair of glasses are located within the glass arm notch and such that the nose of the body top is located within the bridge cavity of the glasses.

2. The article holder of claim 1, wherein the body bottom includes an outer surface treated with an automobile-grade adhesive to ensure that the article holder remains in place on the dashboard of a vehicle.
